(19) United States
(12) Patent Application Publication
(10) Pub. No.: US 2022/0362915 A1
(43) Pub. Date: Nov. 17, 2022

(54) WIRE STAPLER

(71) Applicant: Christopher Dumph, Blackhawk, CO (US)

(72) Inventor: Christopher Dumph, Blackhawk, CO (US)

(21) Appl. No.: 17/322,355

(22) Filed: May 17, 2021

(51) Int. Cl. B25C 5/11; B25C 5/06; B25C 11/00; B25C 5/16

(52) U.S. Cl. CPC B25C 5/11; B25C 5/06; B25C 11/00; B25C 5/1637; B25G 1/04

(57) ABSTRACT

A wire stapler for tacking an elongate element at an elevated location is disclosed herein. The element may be one of a cable, a rope light, decorations, and the like. The wire stapler comprises a handle. An elongate hammer is coupled to the handle and extends therefrom. An elongate sleeve is configured to receive the elongate hammer therewithin. A sleeve end is configured for coupling at an operative end of the sleeve, wherein the sleeve end includes a staple receiving pocket configured thereon for receiving a staple therein, wherein the hammer is configured for reciprocation within the sleeve and collision with the staple for tacking the element accommodated between the staple at the elevated location.

### TECHNICAL FIELD

The present invention generally relates to wire staplers, and more particularly, to a wire stapler that can be used to tack wires, cables, and other elongate members at elevated locations.

### BACKGROUND

Staplers are generally used as devices known in the art for fastening fabric, cardboard, paper, and similar sheets of material to other sheets of same or different material or to a hard substrate such as plastic, wood, and the like. Some other applications of the staplers include attaching long items, such as electrical wires, cables, or tubes onto a substrate such as wood or other materials.

For example, in typical domestic setups, one of the most common tasks is to tack electrical wires onto a workpiece or surface, such as a floor, a wall, or a wooden surface during the installation of electrical or electronic equipment. Typical staplers may be used to tack a wire. However, typical staplers are configured to eject a metal staple, and in doing so, a pointed edge of the staple may lacerate the insulation layer of the wire. On other instances, the metal bar of the staple may press onto the wire so hard that it cuts and penetrates through the insulation layer, which may damage the electrical characteristics of the conducting wire.

Specially designed staplers have been developed in the art that are directed to the application of tacking a wire. These specially designed wire staplers are similar to the conventional staplers in many aspects. These handheld wire staplers are configured with a provision for ensuring that the wires do not get pierced or lacerated. These wire staplers are convenient for tacking the wires or any other elongate members at locations of easy reach. However, for tacking the wires at elevated locations, one needs to arrange a ladder and then attempt to do the tacking while using the ladder. This may cause accidents, and therefore not desired.

Therefore, there exists a previously unappreciated need for a new and improved wire stapler that facilitates the functionalities mentioned above and addresses the shortcomings of the prior art. It is to these ends that the present invention has been developed.

### SUMMARY

The present subject matter envisages a wire stapler for tacking an elongate element at an elevated location. The elongate element may be one of a cable, a rope light, and decorations. The wire stapler comprises a handle. An elongate hammer is coupled to the handle and extends therefrom. An elongate sleeve is configured to receive the elongate hammer therewithin. A sleeve end is configured for coupling at an operative end of the sleeve, wherein the sleeve end includes a staple receiving pocket configured thereon for receiving a staple therein, wherein the hammer is configured for reciprocation within the sleeve and collision with the staple for tacking the elongate element accommodated between the staple at the elevated location.

In accordance with a non-limiting embodiment, the wire stapler further comprises a hammer slide securely supported within the sleeve end and configured for reciprocal movement within the sleeve end on being impacted via the hammer to push the staple supported on the end sleeve into the elevated location.

In accordance with a non-limiting embodiment, the wire stapler further comprises a pin disposed within the sleeve on which the hammer slide is supported.

In accordance with a non-limiting embodiment, the wire stapler further comprises at least one magnet provided within the sleeve end for magnetically holding on to the staple on the sleeve end.

In accordance with a non-limiting embodiment, the wire stapler further comprises a groove configured on the sleeve end for accommodating the elongate element to be tacked therein.

In accordance with a non-limiting embodiment, the wire stapler further comprises a staple holder configured for assembly with the sleeve end, wherein the staple holder defines a staple receiving pocket for accommodating the staple therein.

In accordance with a non-limiting embodiment, the staple holder includes a depression that aligns with the groove subsequent to the assembly of the staple holder in the sleeve end in an orientation orthogonal to that of the groove, thereby allowing the placement of the staple in the staple receiving pocket orthogonal to the length of the groove and accommodating the elongate element between arms of the staple within the groove.

In accordance with a non-limiting embodiment, the wire stapler further comprises a cable guide configured for assembly over the sleeve end. In one embodiment, the cable guide includes a cable guide base having a pair of guide wings extending outwardly from the cable guide base. The pair of guide wings assist a user to guide the elongate element within the staple held on the sleeve end.

In accordance with a non-limiting embodiment, the wire stapler further comprises a hook configured for assembly on the operative end of the elongate sleeve. In one embodiment, the hook has a hook base and at least one prong extending therefrom in a direction substantially orthogonal to the length of the hook base.

The present subject matter envisages a wire stapler for tacking an elongate element at an elevated location. The wire stapler comprises a handle. An elongate hammer is coupled to the handle and extends therefrom. At least one elongate hammer extension is configured for coupling with the elongate hammer. An elongate sleeve is configured to receive the elongate hammer therewithin. At least one elongate sleeve extension is configured for coupling with the elongate sleeve. A sleeve end configured for coupling at an operative end of the at least one elongate sleeve extension, wherein the sleeve end includes a staple receiving pocket configured thereon for receiving a staple therein, wherein the hammer is configured for reciprocation within the sleeve and collision with the staple for tacking the elongate element accommodated between the staple at the elevated location.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A illustrates a top view of a wire stapler for tacking an elongate element at an elevated location, in accordance with an embodiment of the present subject matter.

FIG. 1B illustrates an exploded view of the wire stapler for tacking an elongate element at an elevated location, in accordance with an embodiment of the present subject matter.

FIG. 1C illustrates another top view of the wire stapler having cable guide installed thereon, in accordance with an embodiment of the present subject matter.

FIG. 1D and FIG. 1E illustrate views of a hook configured for assembly on a distal end of the wire stapler, in accordance with an embodiment of the present subject matter.

FIG. 1F illustrates a schematic view depicting the assembly of the hook on the wire stapler, in accordance with an embodiment of the present subject matter.

FIG. 2A through FIG. 2D illustrate perspective views of a sleeve end used in the wire stapler, in accordance with another embodiment of the present subject matter.

FIG. 3A through FIG. 3C illustrate perspective views of a sleeve end used in the wire stapler, in accordance with another embodiment of the present subject matter.

FIG. 4 illustrates a perspective view of a sleeve end used in the wire stapler, in accordance with another embodiment of the present subject matter.

FIG. 5A through FIG. 5B illustrate perspective views of a sleeve end used in the wire stapler, in accordance with another embodiment of the present subject matter.

FIG. 6A and FIG. 6B illustrate views of wire stapler for tacking an elongate element at an elevated location, in accordance with an embodiment of the present subject matter.

### DETAILED DESCRIPTION OF EXAMPLE EMBODIMENTS

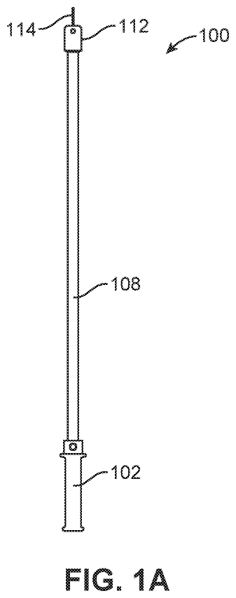

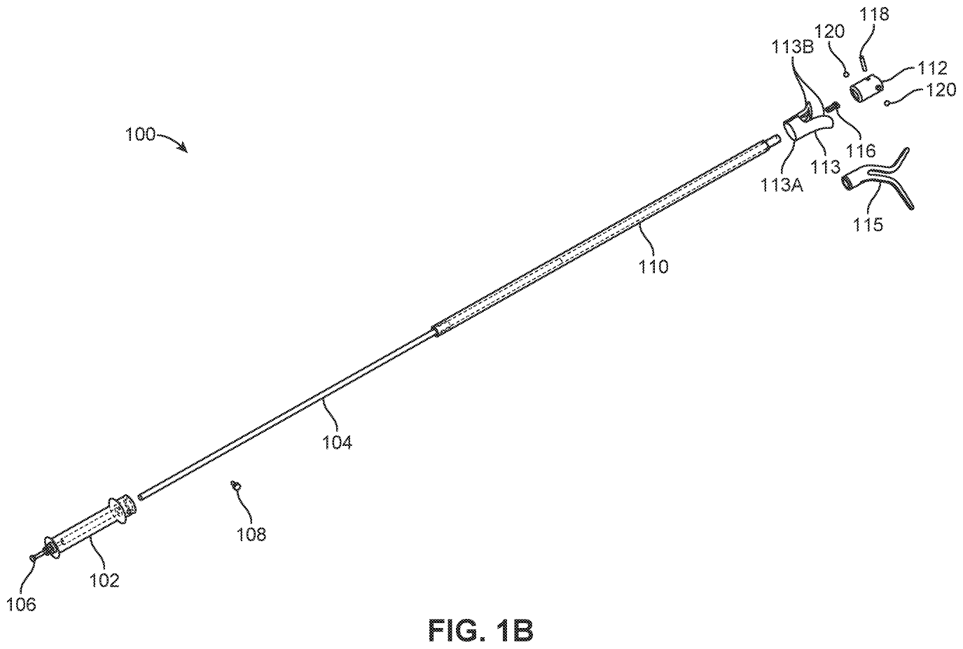

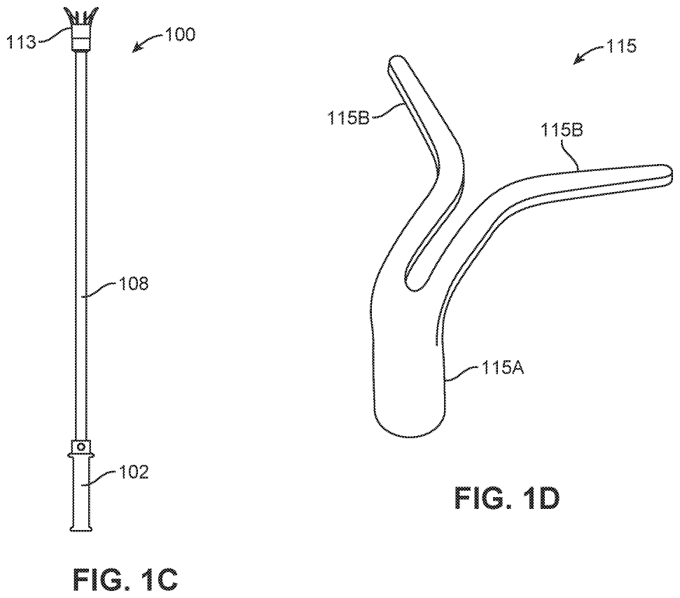

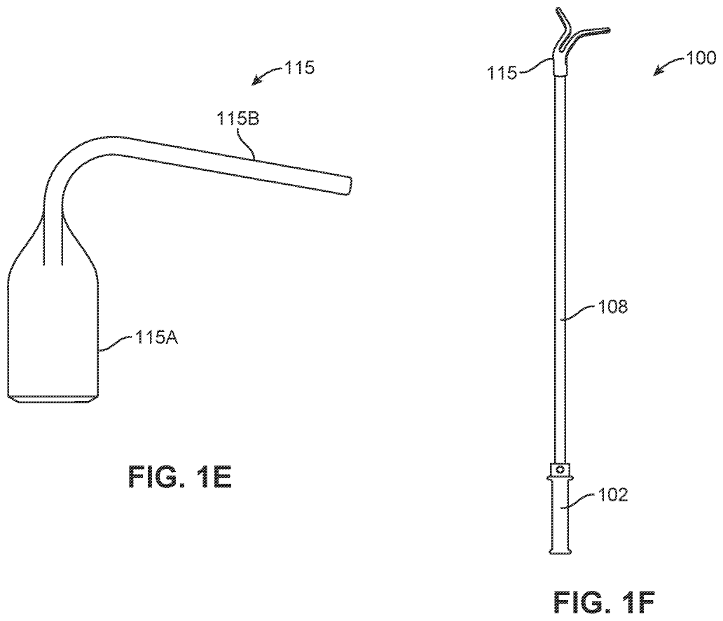

FIG. 1A and FIG. 1B illustrate views of a wire stapler 100 for tacking an elongate element at an elevated location, in accordance with an embodiment of the present subject matter. The elongate element, in accordance with an embodiment, may be wires, cables, rope lights, decorations, and the like. Referring to FIG. 1A and FIG. 1B, the wire stapler 100 comprises a handle 102. The wire stapler 100 further comprises an elongate hammer 104 (hereinafter interchangeably referred to as hammer 104). In accordance with an embodiment of the present subject matter, the hammer 104 is an elongate rod that is partially received into and coupled to the handle 102 via a first fastener 106. The wire stapler 100 further comprises a second fastener 108, which is a thumb fastener provided adjacent an operative top end of the handle 102.

The wire stapler 100 further comprises an elongate sleeve 110 (hereinafter interchangeably referred to as sleeve 110). The sleeve 110, in accordance with an embodiment of the present subject matter, is a rigid hollow tube configured for allowing a reciprocal movement of the hammer 104 therewithin. More specifically, a user of the wire stapler 100 may hold onto the handle 102 having the hammer 104 extending therefrom and maneuver the hammer 104 to reciprocate within the sleeve 110. As the name suggests, the hammer 104 is to be reciprocated with a certain momentum to successfully complete the tacking operation. The process of tacking the elongate element at the elevated location is described in more detail in the subsequent sections of the present disclosure.

The wire stapler 100 further comprises a sleeve end 112 configured for assembly on a free end of the sleeve 110. The sleeve end 112 includes a staple receiving pocket either configured thereon or configured on another member assembled on the sleeve end 112, as is explained in the subsequent sections of the present disclosure. The sleeve end 112 also has a hollow configuration. After assembly of the sleeve end 112 on the sleeve 110, a staple 114 is placed in the staple receiving pocket, and the hammer 104 that is configured to reciprocate in the sleeve 110 facilitates the provision of an impact on the staple 114 that is partially received within the sleeve end 112 while being accommodated within the staple receiving pocket. It is to be noted that the second fastener 108 locks the sleeve 110 and the hammer 104 together to make the process of loading the staple 114 in the sleeve end 112 easier for the user.

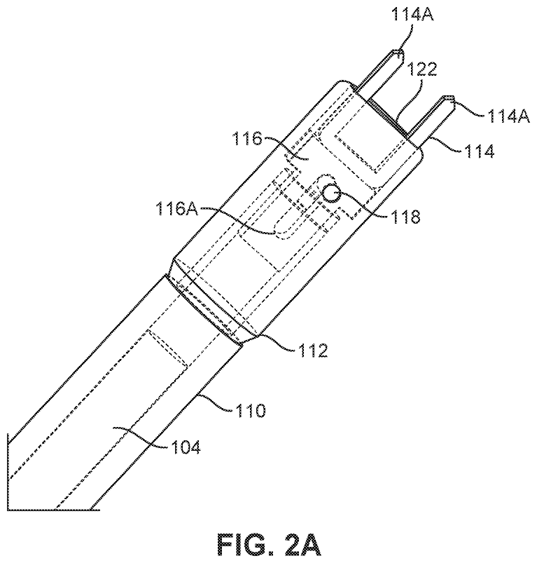

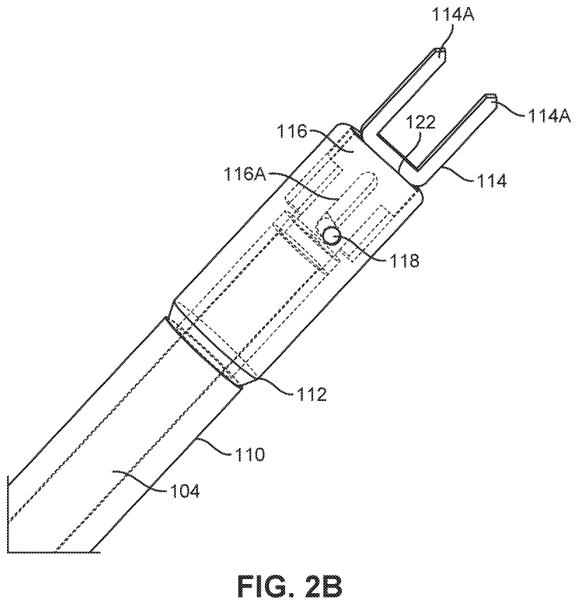

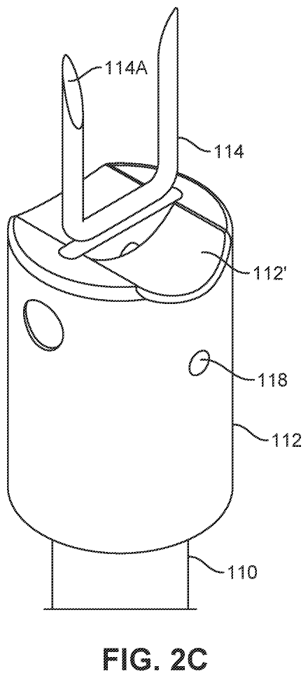

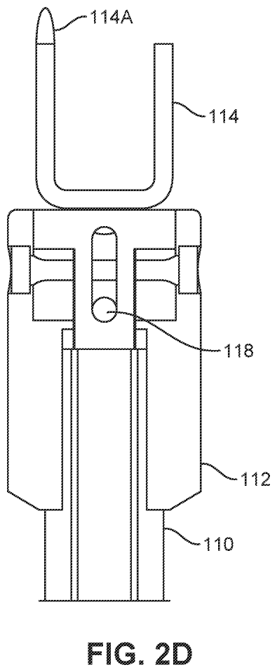

The wire stapler 100 further comprises a hammer slide 116, a pin 118, and at least one magnet 120 configured for assembly within the sleeve end 112. FIG. 2A and FIG. 2B illustrate perspective views depicting the various components assembled in the sleeve end 112, in accordance with an embodiment of the present subject matter. Referring to FIG. 2A and FIG. 2B, the hammer slide 116 includes a hammer slide slot 116A. The hammer slide 116, in accordance with one embodiment, has a T-shaped configuration, wherein the length of a top edge of the hammer slide 116 corresponds to the size of the staple supported in a staple receiving pocket 122 of the sleeve end 112. The staple receiving pocket 122 may be configured on the sleeve end 112 in accordance with one embodiment. In another embodiment, the staple receiving pocket 122 may be configured on a staple holder configured for assembly on the sleeve end 112.

The wire stapler 100 further comprises a cable guide 113. FIG. 1C illustrates another top view of the wire stapler 100 having the cable guide 113 installed thereon, in accordance with an embodiment of the present subject matter. The cable guide 113 is an element that is configured for assembly over the sleeve end 112. The cable guide 113 includes a cable guide base 113A and a pair of cable guide wings 113B extending outwardly from the cable guide base 113A. The cable guide base 113A has a hollow cylindrical configuration that includes a diameter slightly larger than that of the sleeve end 112 to allow a snug fitment of the cable guide 113 on the sleeve end 112. The pair of guide wings 113B assist a user to guide the elongate element, such as a cable, a rope light, decorations, and the like, within the staple 114 held on the sleeve end 112.

The wire stapler 100 further comprises a hook 115. FIG. 1D and FIG. 1E illustrate views of the hook 115 configured for assembly on a distal end of the wire stapler 100, in accordance with an embodiment of the present subject matter. The hook 115 is configured for assembly on the operative end of the elongate sleeve 110. In one embodiment, the hook 115 has a hook base 115A and at least one prong 115B extending therefrom in a direction substantially orthogonal to the length of the hook base 115A. The hook 115 is assembled on the elongate sleeve 110 to allow the user to pull out the tacked elongate elements once their purpose is served. More specifically, the user does not need to use a ladder to remove the tacked cables, wires, and the likes. The user only needs to remove the sleeve end 112 from the elongate sleeve 110 and assemble the hook 115 in its place, as seen in FIG. 1F that illustrates a schematic view depicting the assembly of the hook 115 on the wire stapler 100, in accordance with an embodiment of the present subject matter.

Referring to FIG. 2A and FIG. 2B, the pin 118 is supported between apertures configured on the sleeve end 112. The hammer slide 116 is supported within the sleeve end 112 via the pin 118, as seen in FIG. 2A and FIG. 2B. More specifically, the hammer slide slot 116A facilitates the hanging of the hammer slide 116 on the pin 118 within the sleeve end 112. Therefore, the hammer slide 116 remains in a suspended state within the sleeve end 112. Referring to FIG. 1B, the wire stapler 100 further comprises the at least one magnet 120 that is configured for fitment into apertures configured on the sleeve end 112. The magnets 120 provide the magnetism required for holding the staple 114 securely within the staple receiving pocket 122 to ensure that the staple 114 does not get displaced while the user uses the wire stapler 100 to tack the wires or other elongate items at elevated locations.

Referring to FIG. 2C and FIG. 2D, the sleeve end 112D is depicted having a slightly larger diameter than the sleeve end 112 depicted in FIG. 2A and FIG. 2B. Such a feature allows the user to interchange sleeve ends in accordance with the size of the staple to be used for the tacking operation. The sleeve end 112 comprises a cable receiving groove 112′ configured on the operative top end of the sleeve end 112. The groove 112′ facilitates a snug fitment of the elongate element between the arms 114A of the staple 114. Furthermore, the sleeve end 112D includes apertures 120A that allow the placement of magnets 120 therein.

The operational configuration of the wire stapler 100, in accordance with an embodiment of the present subject matter, is hereafter described with reference to FIG. 1B through FIG. 2B. While using the wire stapler 100, the first thing required is to place the staple 114 within the staple receiving pocket 122, as seen in FIG. 2B. The magnets 120 ensure that the staple 114 remains securely placed within the staple receiving pocket 122 while the user uses the wire stapler 100 to tack wires at elevated locations. Once the staple 114 is placed inside the staple receiving pocket 122, the user takes the elongate element, which may be a wire, cable, rope lights, decorations, and the like, and places the elongate element in between arms 114A of the staple 114. The user then maneuvers the wire stapler 100 having the elongate element placed between the arms 114A of the staple 114 such that the sleeve end 112 having the staple 114 and the elongate element is brought near the desired elevated location. The sleeve end 112 having the staple 114 and the elongate element is pressed against the desired elevated location. In this position, the elongate element is ready to be tacked. For finishing the tacking operation, the user reciprocates the hammer 104 using the handle 102. The movement of the hammer 104 towards the hammer slide 116 is performed with some momentum, such that the hammer 104 collides with the hammer slide 116. This collision then allows the hammer slide 116 to impact the staple 114 and displacing the staple 114 as seen in FIG. 2B. This enables the arms 114A of the staple 114 to pierce through the substrate present at the desired elevated location, and thus tacking the elongate element held between the arms 114A to be tacked at the desired elevated location.

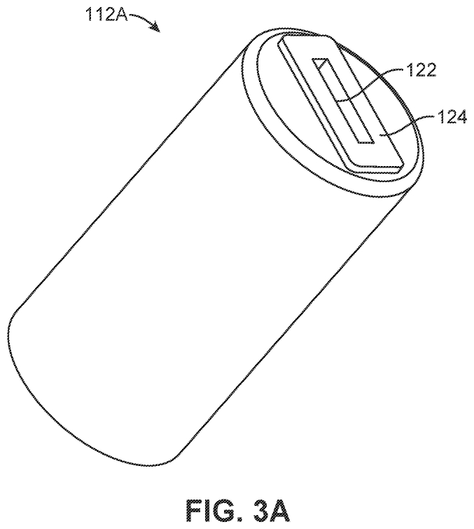

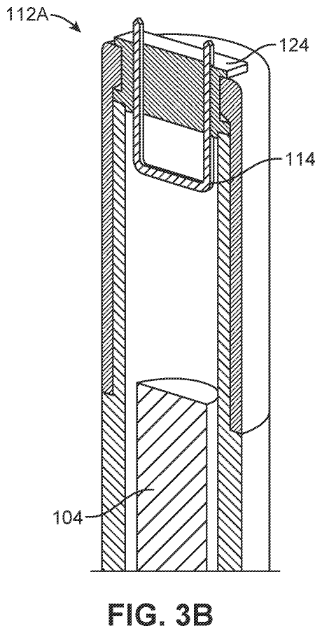

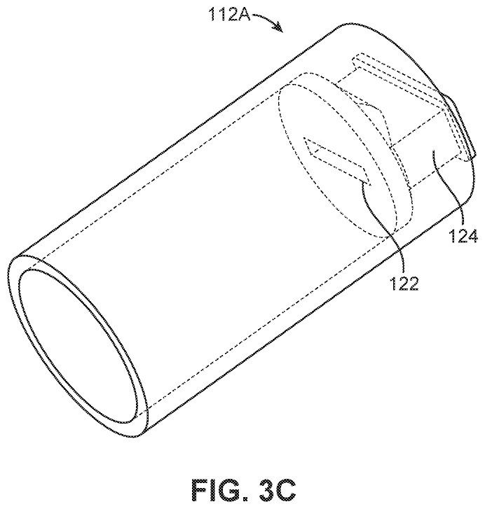

FIG. 3A through FIG. 3C illustrate perspective views of a sleeve end 112A used in the wire stapler 100, in accordance with another embodiment of the present subject matter. The embodiment illustrated in FIG. 3A through FIG. 3C includes a staple holder 124. The staple holder 124 is a discreet component on which the staple receiving pocket 122 is configured, wherein the staple receiving pocket 122 is the pocket in which the user places the staple for tacking the elongate element at the elevated location.

Referring to FIG. 3B and FIG. 3C, the sleeve end 112A has a configuration that is much simpler than the configuration of the sleeve end 112. More specifically, the sleeve end 112A does not include the hammer slide. The staple 114 accommodated within the staple receiving pocket of the staple holder 124 is partially received within the sleeve end 112A and is held in a position to be impacted upon by the hammer 104.

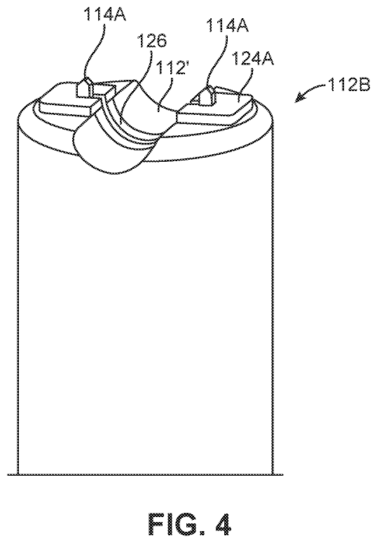

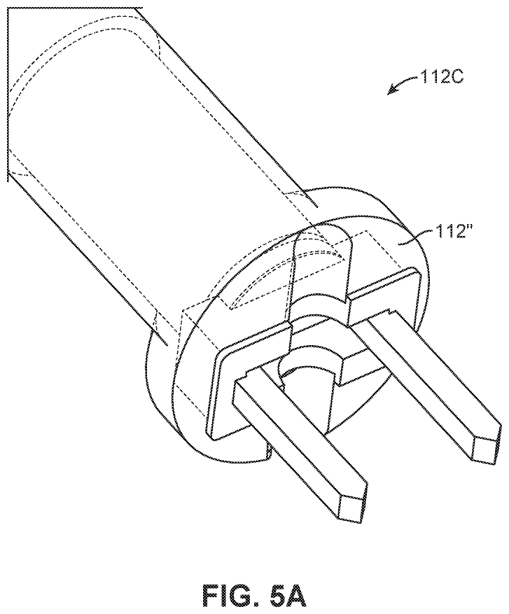

FIG. 4 illustrates a perspective view of a sleeve end 112B used in the wire stapler 100, in accordance with another embodiment of the present subject matter. Referring to FIG. 4, the sleeve end 112B, in accordance with the instant embodiment, includes a staple holder 124A and a cable receiving groove 112′. The staple holder 124A also includes a depression 126 that aligns with the cable receiving groove 112′ on assembly within the staple holder 124A. The alignment of the depression 126 with the groove 112′ of the sleeve end 112B creates space for accommodating an elongate element in between the arms 114A of the staple. An advantageous aspect of such a construction is that it allows the elongate element to be accommodated securely between the arms 114A while being snugly accommodated in the groove 112′.

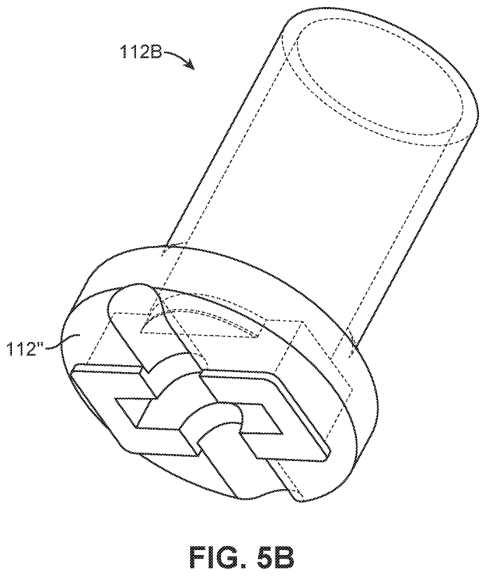

FIG. 5A through FIG. 5B illustrate perspective views of a sleeve end 112C used in the wire stapler 100, in accordance with another embodiment of the present subject matter. The explanation of identical components and features sleeve end 112C and sleeve end 112B (depicted in FIG. 4) are not repeated again herein for the sake of brevity of the present disclosure. The only difference in sleeve end 112C with respect to sleeve end 112B is that a top face 112″ of the sleeve end 112C has a diameter greater than that of sleeve end 112B. More specifically, the sleeve end 112C allows a user to user a wider staple for tacking elongate elements that may be thicker or have a diameter greater than what would be allowed to be tacked by the sleeve end 112B of a smaller diameter. An advantageous aspect of such a feature is that unlike conventional staplers where the staplers are configured to use only a certain specific size of staples, the wire stapler 100 can be configured to be used with staples of different sizes by only changing the sleeve end to in accordance with the size of the staple required.

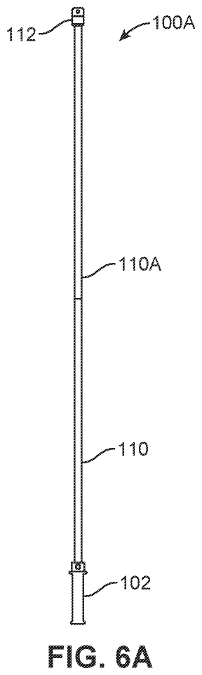

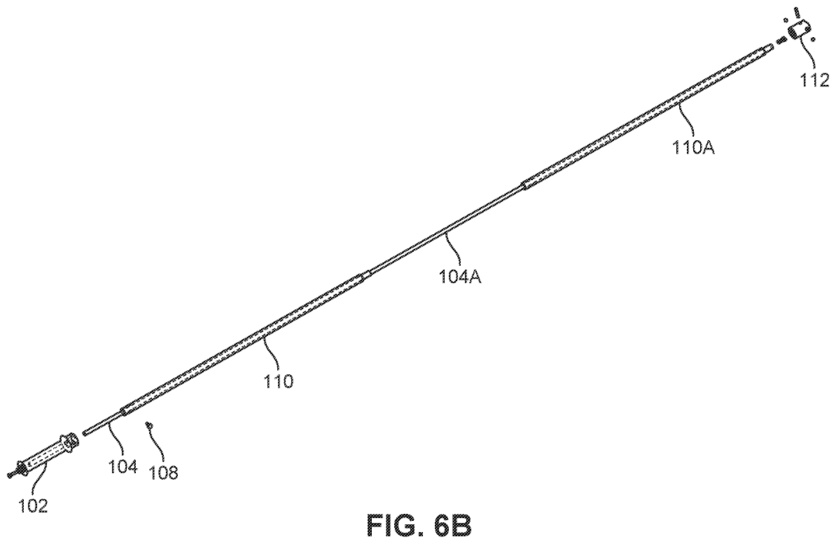

FIG. 6A and FIG. 6B illustrate views of a wire stapler 100A for tacking an elongate element at an elevated location, in accordance with an embodiment of the present subject matter. The wire stapler 100A, in accordance with an embodiment of the present subject matter, is an extendible version of the wire stapler 100 depicted in FIG. 1A and FIG. 1B. Therefore, like elements of the wire stapler 100 and wire stapler 100A are referenced via like numerals. Also, the explanation of the like elements and features in wire stapler 100 and wire stapler 100A is not repeated again for the sake of brevity of the present disclosure.

Referring to FIG. 6A and FIG. 6B, the wire stapler 100A includes extensions to the hammer 104 and the sleeve 110 to allow the user to increase the reach of the wire stapler 100A. The wire stapler 100A comprises at least one elongate hammer extension 104A that is configured to couple to the hammer 104. The construction of the hammer extension 104A is identical to that of the hammer 104, and the hammer extension 104A is configured to mechanically couple with the hammer 104. In accordance with one embodiment, the hammer extension 104A is threadably connected to the hammer 104 such that the hammer extension 104A extends from the hammer. In another embodiment, the hammer extension 104A and the hammer 104 may be configured for snap fitment such that the hammer extension 104A extends from the hammer 104.

The wire stapler 100A further comprises at least one elongate sleeve extension 110A. The sleeve extension 110A is configured to be coupled to the sleeve 110. Similar to the hammer extension 104A, the sleeve extension 110A may be connected to the sleeve 110 via threaded connection according to one embodiment, and via snap fitment in accordance with another alternate embodiment. In accordance with one embodiment, the sleeve extension 110A may have substantially the same length as that of the hammer extension 104A. The sleeve end 112 may be assembled on the free operative end of the sleeve extension 110A. The operation of the wire stapler 100A is identical to that of wire stapler 100 and is therefore not repeated again for the sake of brevity of the present disclosure.

An advantageous aspect of the wire stapler, in accordance with embodiments of the present subject matter, is variable nature of the wire stapler which increases the applicability of the wire stapler. The variable length of the wire stapler, facilitated via the hammer extension and sleeve extension, allows user to tack the elongated elements at different elevations. Furthermore, the interchangeable nature of the sleeve end allows the user to use the staples of different sizes using the same wire stapler.

It will be understood by those of skill in the art that other examples of insert may be specifically configured to receive fasteners with shapes other than those described herein. In other words, cut-out regions may be provided to accommodate features of these differently configured fasteners. Additionally, magnets may be positioned differently from what is disclosed herein to accommodate differently shaped fasteners from those described herein. The slots defined in the top wall of the insert and the plate (or defined in the integral top plate) may be differently positioned and shaped to permit differently configured hammers to move therethrough.

In one embodiment, the stapler may further comprise an insert that is adapted to retain a fastener therein. The insert may be selectively detachably engageable within the bore of the barrel. In one embodiment, the palm stapler may further comprise a retainer mechanism provided on one or both of the insert and the barrel, said retainer mechanism being operative to retain the insert within the bore of the barrel. In one embodiment, the insert may define a slot therein, wherein the slot is configured to be complementary to one or more of a plurality of different fasteners; and wherein the slot is furthermore positioned to receive a lower end of the hammer therethrough.

The foregoing description of the specific embodiments have been described herein above that a person having ordinary skill in the art can apply the current knowledge, readily modify, or adapt for various applications such specific embodiments without departing from the generic concept. All such adaptations and modifications are intended to be comprehended within the meaning and range of equivalents of the disclosed embodiments.

Further, it is to be understood that the terminology employed herein is for the purpose of description and not of limitation. Therefore, while the embodiments herein have been described in terms of preferred embodiments, a person having ordinary skill in the art will readily recognize that the embodiments herein can be practiced with modification within the spirit and scope of the embodiments as described herein.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A wire stapler for tacking an elongate element at an elevated location, the wire stapler comprising:
a handle;
an elongate hammer coupled to the handle and extending therefrom;
an elongate sleeve configured to receiving the elongate hammer therewithin;
a sleeve end configured for coupling at an operative end of the sleeve, the sleeve end includes a staple receiving pocket for receiving a staple therein, wherein the hammer is configured for reciprocation within the sleeve and collision with the staple for tacking the elongate element accommodated between the staple at the elevated location.

2. The wire stapler according to claim 1, further comprising a hammer slide securely supported within the sleeve end and configured for reciprocal movement within the sleeve end on being impacted via the hammer to push the staple supported on the end sleeve into the elevated location.

3. The wire stapler according to claim 2, further comprising a pin disposed within the sleeve on which the hammer slide is supported.

4. The wire stapler according to claim 1, further comprising at least one magnet provided within the sleeve end for magnetically holding on to the staple on the sleeve end.

5. The wire stapler according to claim 1, further comprising a groove configured on the sleeve end for accommodating the elongate element to be tacked therein.

6. The wire stapler according to claim 1, further comprising a staple holder configured for assembly with the sleeve end, wherein the staple holder defines the staple receiving pocket for accommodating the staple therein.

7. The wire stapler according to claim 1, further comprising a cable guide configured for assembly over sleeve end, wherein the cable guide includes a cable guide base having a pair of guide wings extending outwardly from the cylindrical base, wherein the pair of guide wings assist a user to guide the elongate element within the staple held on the sleeve end.

8. The wire stapler according to claim 1, further comprising a hook configured for assembly on the operative end of the elongate sleeve, the hook having a hook base and at least one prong extending therefrom in a direction substantially orthogonal to the length of the hook base.

9. The wire stapler according to claim 5, wherein the staple holder includes a depression that aligns with the groove subsequent to the assembly of the staple holder in the sleeve end in an orientation orthogonal to that of the groove, thereby allowing the placement of the staple in the staple receiving pocket orthogonal to the length of the groove and accommodating the elongate element between arms of the staple within the groove.

10. The wire stapler according to claim 1, wherein the elongate element to be tacked at the elevated location is at least one of a cable, a rope light, and decorations.

11. A wire stapler for tacking an elongate element at an elevated location, the wire stapler comprising:
a handle;
an elongate hammer coupled to the handle and extending therefrom;
at least one elongate hammer extension configured for coupling with the elongate hammer;
an elongate sleeve configured to receiving the elongate hammer therewithin;
at least one elongate sleeve extension configured for coupling with the elongate sleeve;
a sleeve end configured for coupling at an operative end of the at least one elongate sleeve extension, the sleeve end having a staple receiving pocket configured thereon for receiving a staple therein, wherein the hammer is configured for reciprocation within the sleeve and collision with the staple for tacking the elongate element accommodated between the staple at the elevated location.
